(19) United States
(12) Patent Application Publication
(10) Pub. No.: US 2011/0008216 A1
(43) Pub. Date: Jan. 13, 2011

(54) HYDROGEN GENERATOR

(75) Inventors: Takeshi Miki, Ibaraki-shi (JP); Toshihiro Nakai, Ibaraki-shi (JP); Shoji Saibara, Ibaraki-shi (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi, Osaka (JP)

(21) Appl. No.: 12/919,713

(22) PCT Filed: Feb. 27, 2009
(86) PCT No.: PCT/JP2009/053687

§ 371 Date: Sep. 23, 2010

(30) Foreign Application Priority Data
Feb. 27, 2008 (JP) 2008-046309

(51) Int. Cl. B01J 19/00

(52) U.S. Cl. 422/162

(57) ABSTRACT

A hydrogen generator of the present invention has a vessel for containing a hydrogen generating material including a metallic material for generating hydrogen by an exothermic reaction with water. The vessel includes a water supply pipe for supplying water into the vessel and a hydrogen outlet for discharging hydrogen generated in the vessel to the outside of the vessel. In the hydrogen generator, a wall surface of the vessel facing the hydrogen outlet is set as a reference plane, a water supply port at the end of the water supply pipe disposed inside the vessel is disposed in the vicinity of the reference plane, the water supply pipe includes a perpendicular portion extending from the vicinity of the center of the reference plane in a direction perpendicular to the reference plane, and a water absorbent is disposed on the periphery of the perpendicular portion of the water supply pipe and not disposed on a portion of 15% or more of an effective length of the perpendicular portion on the hydrogen outlet side.

### TECHNICAL FIELD

The present invention relates to a hydrogen generator using a metallic material that reacts with water so as to generate hydrogen.

### BACKGROUND ART

With the recent widespread use of cordless equipment such as a personal computer or a portable telephone, secondary batteries used as a power source of cordless equipment are increasingly required to have a smaller size and higher capacity. At present, a lithium ion secondary battery that can achieve a small size, light weight, and high energy density is being put to practical use and growing in demand as a portable power source. However, depending on the type of cordless equipment to be used, the lithium ion secondary battery is not yet reliable enough to ensure a continuous available time.

Under these circumstances, a polymer electrolyte fuel cell has been studied as an example of a battery that may meet the above requirements. The polymer electrolyte fuel cell uses a solid polymer electrolyte as its electrolyte, oxygen in the air as a positive active material, and a fuel (hydrogen, methanol, etc.) as a negative active material, and has attracted considerable attention because it is a battery that can be expected to have a higher energy density than a lithium ion secondary battery.

Fuel cells can be used continuously as long as a fuel and oxygen are supplied. Although there are several candidates for fuels used for the fuel cells, the individual fuels have various problems, and a final decision has not been made yet.

For example, when a fuel cell uses hydrogen as a fuel, a method for supplying hydrogen stored in a high-pressure tank or hydrogen-storing alloy tank is employed to some extent. However, a fuel cell using such a tank is not suitable for a portable power source, since both the volume and the weight of the fuel cell are increased, and the energy density is reduced.

When a fuel cell uses a hydrocarbon fuel, another method for extracting hydrogen by reforming a hydrocarbon fuel may be employed. However, a fuel cell using hydrocarbon fuel requires a reformer and thus poses problems such as supply of heat to the reformer and thermal insulation. Therefore, this fuel cell is not suitable for a portable power source either. Moreover, a direct methanol fuel cell, in which methanol is used as a fuel and reacts directly at the electrode, is miniaturized easily and expected to be a future portable power source. However, a direct methanol fuel cell causes a reduction in both voltage and energy density due to a crossover phenomenon in which methanol at the negative electrode passes through the solid electrolyte and reaches the positive electrode.

Under these circumstances, a method of producing hydrogen as a fuel source for a fuel cell has been proposed, which is a method of generating hydrogen by the chemical reaction of water and a hydrogen generating material such as aluminum, magnesium, silicon, or zinc at a low temperature of 100° C. or less (see, e.g., Patent Documents 1 and 2).

However, according to the method as described in Patent Document 1, hydrogen cannot he generated without addition of at least 15 weight % of calcium oxide with respect to the total amount including the aluminum. Moreover, the hydrogen generation rate fluctuates considerably over the reaction time, and it will cause serious problems in view of the efficiency and stability of hydrogen generation reaction.

Similarly, according to the method as described in Patent Document 2, a large amount of additives are required to advance the hydrogen generation reaction efficiently, and thus the Patent Document 2 cannot provide a method for generating hydrogen in an efficient and stable manner.

The present inventors conducted studies several times to avoid the above-mentioned problems inherent in the methods as described in Patent Documents 1 and 2, thereby developing and proposing a technique in Patent Document 3. The method is a hydrogen generating method that includes a step of supplying water into a vessel containing a hydrogen generating material that generates hydrogen by an exothermic reaction with water, and a step of generating hydrogen by allowing a reaction between the water and the hydrogen generating material inside the vessel, where the water supply amount is controlled in the water supply step so as to keep temperature inside the vessel to a temperature for maintaining the exothermic reaction, and thus suppressing fluctuation in the hydrogen generation rate. According to the technique as described in Patent Document 3, the hydrogen generation reaction can be maintained stably, and thus hydrogen can be generated efficiently and stably in a simple manner.

Further, for generating hydrogen more efficiently, the present inventors developed a hydrogen generating material including a metallic material that reacts with water so as to generate hydrogen and an exothermic material that reacts with water so as to generate heat and that composes a material other than the metallic material, where the exothermic material is distributed unevenly in the metallic material, and a hydrogen generator using the hydrogen generating material. The hydrogen generating material and the hydrogen generator are proposed in Patent Document 4.

Patent document 1: JP 2004-231466 A
Patent document 2: JP 2004-505879 A
Patent document 3: JP 2007-45646 A
Patent document 4: WO 2007-018244

However, it has been clarified that even the techniques as disclosed in Patent Documents 3 and 4 are still susceptible to improvement in the structure of the vessel containing the hydrogen generating material, from the viewpoint of improving the hydrogen generation efficiency

### DISCLOSURE OF INVENTION

Therefore, with the foregoing in mind, it is an object of the present invention to provide a hydrogen generator that is capable of generating hydrogen efficiently in a simple manner.

A hydrogen generator of the present invention is a hydrogen generator including a vessel for containing a hydrogen generating material including a metallic material for generating hydrogen by an exothermic reaction with water. The vessel has a water supply pipe for supplying water into the vessel and a hydrogen outlet for discharging hydrogen generated inside the vessel to the outside of the vessel; a wall surface of the vessel facing the hydrogen outlet is set as a reference plane; a water supply port at the end of the water supply pipe disposed inside the vessel is disposed in the vicinity of the reference plane; the water supply pipe has a perpendicular portion extending from the vicinity of the center of the reference plane in a direction perpendicular to the reference plane; a water absorbent is disposed on the periphery of the perpendicular portion of the water supply pipe; and the water absorbent is not disposed on a portion of 15% or more of an effective length of the perpendicular portion on the hydrogen outlet side.

According to the present invention, a hydrogen generator capable of generating hydrogen efficiently in a simple manner can be provided.

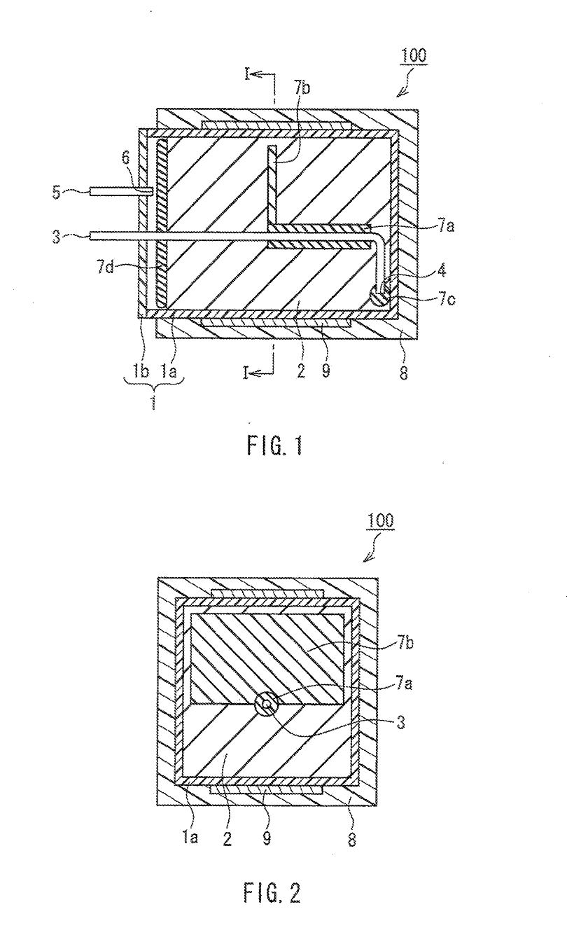

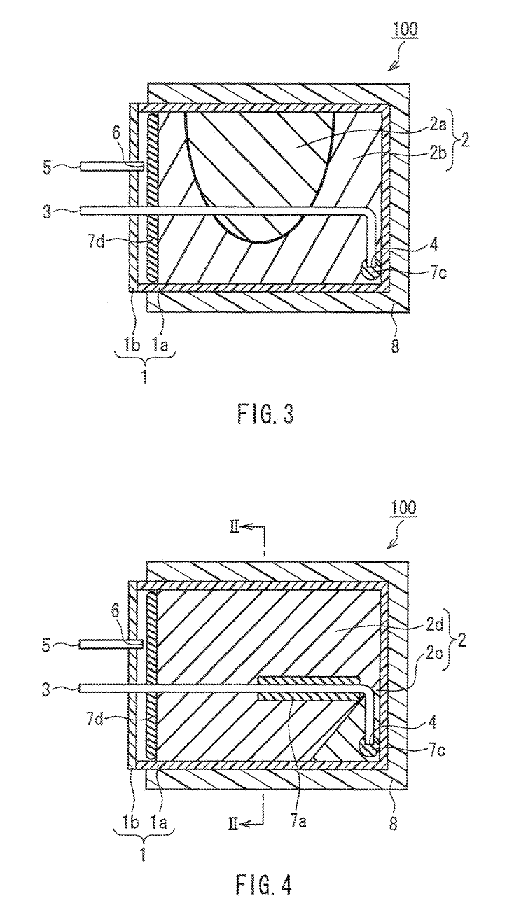

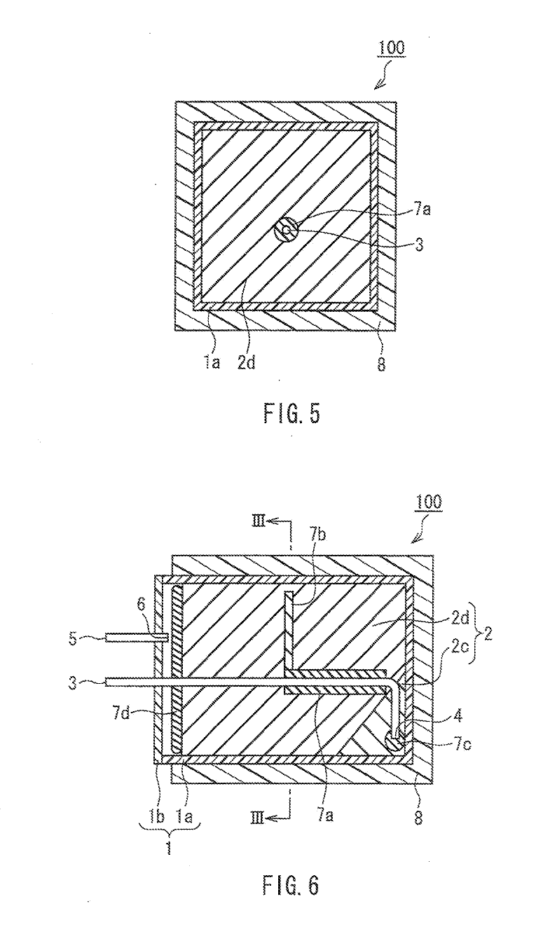

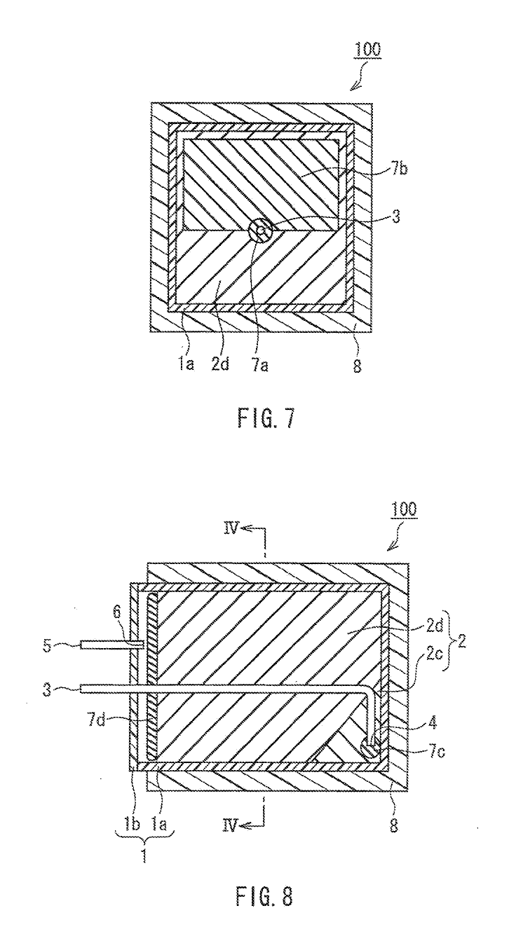

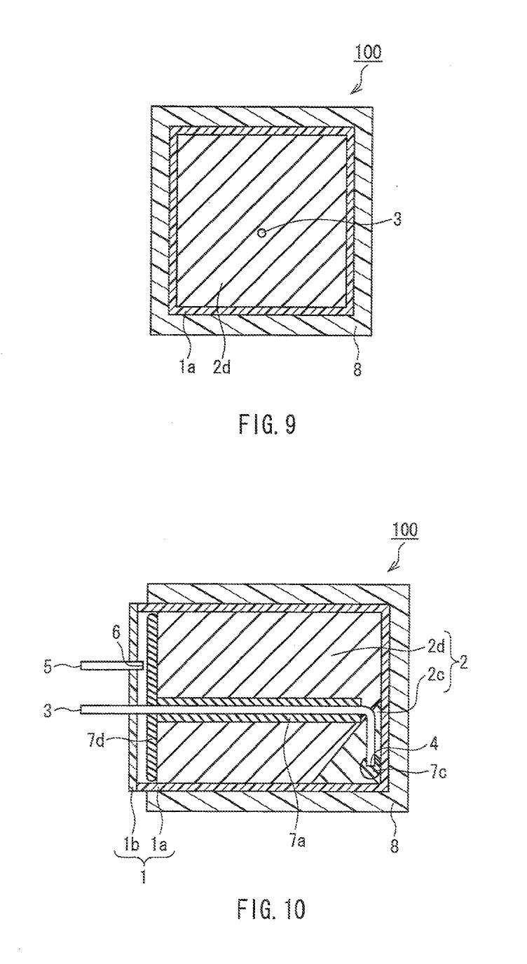

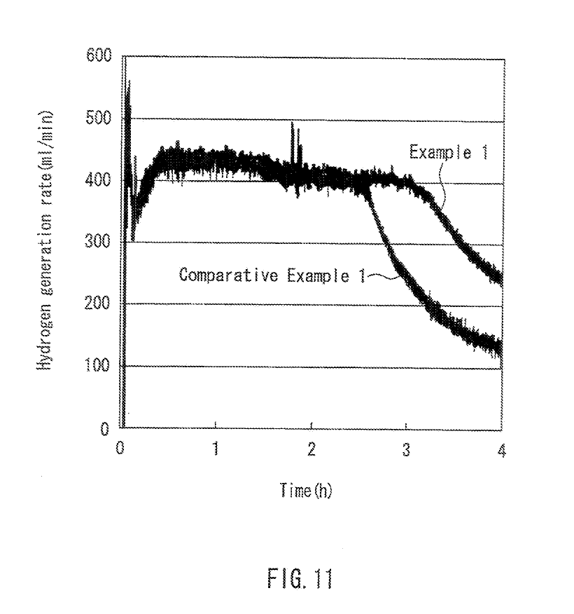

### BRIEF DESCRIPTION OF DRAWINGS

[FIG. 1] FIG. 1 is a schematic cross-sectional view showing a fuel cartridge as an example of a hydrogen generator of the present invention.

[FIG. 2] FIG. 2 is a cross-sectional view taken along a line I-I in FIG. 1.

[FIG. 3] FIG. 3 is a schematic cross-sectional view showing a fuel cartridge during a hydrogen generation reaction, in a case where a water absorbent is not disposed on the periphery of a water supply pipe.

[FIG. 4] FIG. 4 is a schematic cross-sectional view showing a fuel cartridge used in Example 1.

[FIG. 5] FIG. 5 is a cross-sectional view taken along a line II-II in FIG. 4.

[FIG. 6] FIG. 6 is a schematic cross-sectional view showing a fuel cartridge used in Example 4.

[FIG. 7] FIG. 7 is a cross-sectional view taken along a line III-III in FIG. 6.

[FIG. 8] FIG. 8 is a schematic cross-sectional view showing a fuel cartridge used in Comparative Example 1.

[FIG. 9] FIG. 9 is a cross-sectional view taken along a line IV-IV in FIG. 8.

[FIG. 10] FIG: 10 is a schematic cross-sectional view showing a fuel cartridge used in Comparative Example 3.

[FIG. 11] FIG. 11 is a graph showing a relationship between hydrogen generation rates and elapsed times in Example 1 and Comparative Example 1.

### DESCRIPTION OF THE INVENTION

A metallic material used in a hydrogen generator of the present invention is formed of metals such as aluminum, silicon, zinc and magnesium, or an alloy based on any of these metallic elements, and the metallic material is used in the form of particles shaped variously. Such a particle is composed typically of a particle core containing the metal or the alloy in a metallic state, and a surface film (oxide film) that covers at least a part of the particle core. And during a reaction between the metallic material and water, the water penetrates into the surface film, and when the water reaches the metal or alloy composing the particle core, the water and the metallic material react to generate hydrogen.

For example, a reaction between aluminum as one of the metallic materials and water is considered as proceeding in accordance with any of the Formulae (1)-(3) below. The calorific value in the Formula (1) is 419 kJ/mol.

2Al+6H₂O→Al₂O₃.3H₂O+3H₂ (1)

2Al+4H₂O→Al₂O₃.H₂O+3H₂ (2)

2Al+3H₂O→Al₂O₃+3H₂ (3)

In the reactions of the above Formulae (1) and (2) that are considered as occurring preferentially at low temperature of not higher than 100° C., a hydrate is firmed as a reaction product. Since this hydrate is also poorly water-soluble, it also remains on the surface of the particles of the metallic material so as to increase the thickness of the oxide film. And a phenomenon that the hydrate remaining on the particle surface and an unreacted metallic material coagulate will occur. Due to this phenomenon, water penetration into the particle cores of the unreacted metallic material is hindered. Therefore, in a case of generating hydrogen by using the techniques of the above-described Patent Documents 3 and 4 inside the vessel containing the hydrogen generating material including the metallic material, the above-described phenomenon will occur easily depending on the reaction condition, which may cause inconveniences. Namely, inhomogeneous reaction of the hydrogen generating materials may proceed in the vessel and the hydrogen generation efficiency may deteriorate.

However, as a result of keen studies, the present inventors discovered that the hydrogen generation amount can be increased to allow efficient hydrogen generation, by improving the structure of the hydrogen generator that generates hydrogen by using a hydrogen generating material and water that may cause the above-mentioned phenomenon, and thus the present invention is completed.

Namely, the hydrogen generator of the present invention is a hydrogen generator including a vessel for containing a hydrogen generating material including a metallic material for generating hydrogen by an exothermic reaction with water. The vessel has a water supply pipe for supplying water into the vessel and a hydrogen outlet for discharging hydrogen generated inside the vessel to the outside of the vessel; a wall surface of the vessel facing the hydrogen outlet is set as a reference plane; a water supply port at the end of the water supply pipe disposed inside the vessel is disposed in the vicinity of the reference plane; the water supply pipe has a perpendicular portion extending from the vicinity of the center of the reference plane in a direction perpendicular to the reference plane; a water absorbent is disposed on the periphery of the perpendicular portion of the water supply pipe; and the water absorbent is not disposed on a portion of 15% or more of an effective length of the perpendicular portion on the hydrogen outlet side.

By using the hydrogen generator of the present invention, it is possible to generate hydrogen efficiently in a simple manner. The expression “effective length of perpendicular portion” in the instant description indicates the total length of a portion of the perpendicular portion in contact with the hydrogen generating material in a direction perpendicular to the reference plane, in a case where the water absorbent is not disposed on the periphery of the perpendicular portion.

Hereinafter, an example of the hydrogen generator of the present invention will be specified with reference to the drawings. FIG. 1 is a schematic cross-sectional view showing a fuel cartridge as an example of a hydrogen generator of the present invention. FIG. 2 is a cross-sectional view taken along a line I-I in FIG. 1. FIGS. 1 and 2 show an example of hydrogen generator of the present invention, but the hydrogen generator of the present invention is not limited to the structure as shown in FIGS. 1 and 2.

In FIG. 1, the fuel cartridge 100 has a vessel body la that can contain a hydrogen generating material, and a lid 1b. The lid 1b is provided with a water supply pipe 3 for supplying water into the vessel body la and a hydrogen discharging pipe 5 for discharging hydrogen. In FIG. 1, the water supply pipe 3 is disposed horizontally (left-right direction in FIG. 1), but alternatively, it can be disposed vertically (top-bottom direction in FIG. 1). The water supply pipe 3 is L-letter shaped in FIG. 1, but alternatively, water supply pipe 3 can be shaped linearly as a whole.

The fuel cartridge 100 supplies water into the vessel 1 through a water supply port 4 of the water supply pipe 3 by using a pump (not shown) such as a micro-pump. In the vessel 1, a hydrogen generating material 2 and the water are made to react with each other to generate hydrogen. Therefore, the vessel 1 functions also as a reactor vessel in which a reaction between the hydrogen generating material 2 and water occurs. Hydrogen generated in the vessel 1 passes the hydrogen discharging pipe 5 from a hydrogen outlet 6, and supplied to equipment such as a fuel cell that needs hydrogen.

The vessel 1 is not limited particularly in the material and the shape as long as it can contain the hydrogen generating material 2. However, since the vessel 1 is used as a reactor vessel for conducting a hydrogen generation reaction between the hydrogen generating material 2 and water, materials and shapes that do not allow leakage of water and hydrogen from any parts other than the water supply port 4 and the hydrogen outlet 6 are preferred. Specifically, materials preferably used for the vessel 1 are difficult to pass water and hydrogen and prevent the vessel from breakage even heated to approximately 100° C. Applicable examples include metals such as aluminum, titanium, nickel and iron, and resins such as polyethylene, polypropylene and polycarbonate. For the shape of the vessel 1, prismatic shape, a columnar shape or the like can he employed.

The hydrogen outlet 6 is not limited particularly as long as it is configured to discharge hydrogen to the outside. For example, it can be an opening formed on the lid 1b. Alternatively, a pipe (corresponding to the hydrogen discharging pipe 5) connected directly to the lid 1b can be used as a hydrogen outlet. It is more preferable that a filter is disposed at the hydrogen outlet 6 since contents in the vessel 1 are prevented from leaking to the outside. This filter is not limited particularly as long as it is configured to pass gases but hardly to pass liquids and solids. For example, a gas-liquid separation membrane made of porous polytetrafluoroethylene (PTFE), a porous film made of polypropylene or the like, can be used.

In FIG. 1, when the wall surface of the vessel 1 facing the hydrogen outlet 6 is set as a reference plane, the water supply port 4 at the end of the water supply pipe 3 disposed inside the vessel 1 is disposed in the vicinity of the reference plane. In the instant description, “in the vicinity of reference plane” indicates a range that the perpendicular distance from the reference plane is not more than the double of the maximum outer diameter of the water supply port 4. The water supply pipe 3 has a perpendicular portion extending in a direction perpendicular to the reference plane from the vicinity of the center of the reference plane. In the instant description, “vicinity of center of reference plane” indicates a range that a planar distance from the center on the reference plane is the length not more than four times the maximum outer diameter of the water supply port 4.

As described in detail below, it is further preferable that the water supply pipe 3 is connected to a pump capable of controlling water supply amount, since the amount of generated hydrogen can be controlled by adjusting the water supply amount.

A water absorbent 7a is disposed on the periphery of the perpendicular portion of the water supply pipe 3, but it is not disposed on the portion of 15% or more of the effective length (hereinafter, this may be recited simply as effective length) of the perpendicular portion on the hydrogen outlet 6 side. It is further preferable that the water absorbent 7a is not disposed on the portion of 19% to 69% of the effective length on the hydrogen outlet 6 side.

By disposing the water absorbent 7a as described above, it is possible to generate hydrogen efficiently. Though the details for this reason have not been clarified, an adoptable reason derived from a comparison with a hydrogen generator without a water absorbent 7a on the periphery of the water supply pipe 3 will be briefed below. FIG. 3 is a schematic cross-sectional view showing a fuel cartridge having the substantially same structure as the fuel cartridge 100 of FIG. 1 except that no water absorbent is disposed on the periphery of the water supply pipe 3. In FIG. 3, components identical to those in FIG. 1 are assigned with identical signs for avoiding duplication of the description.

FIG. 3 is a schematic cross-sectional view showing a fuel cartridge 100 during a hydrogen generation reaction (at the termination of a steady state) conducted without disposing a water absorbent on the periphery of the water supply pipe 3. The right side in FIG. 3 indicates the reference plane side of the vessel 1, and the left side indicates the hydrogen outlet 6 side. Further, the schematic cross-sectional view of FIG. 3 is based on a result observing the fuel cartridge 100 with an X-ray CT.

In the instant description, “steady state” indicates a state where a hydrogen generation rate attains the maximum value and then the hydrogen generation rate becomes substantially constant.

As clearly shown in FIG. 3, a hydrogen generation reaction proceeds from the water supply port 4 disposed in the vicinity of the reference plane of the vessel 1, but the reaction does not proceed homogeneously towards the left side from the right side of the hydrogen generating material 2 at which the water supply port 4 is disposed. Rather, it was found that an unreacted hydrogen generating material 2a accumulates selectively at the upper center of the vessel 1, and a reacted hydrogen generating material 2b is present surrounding the unreacted hydrogen generating material 2a. The reason is considered as follows. As described above, during a reaction between the metallic material included in the hydrogen generating material 2 and water, a phenomenon that a hydrate as a reaction product remaining on the particle surface of the metallic material and an unreacted metallic material coagulate occurs at the boundary (the thick line in FIG. 3) between the unreacted hydrogen generating material 2a and the reacted hydrogen generating material 2b, and thus it became difficult for the water to penetrate into the particles of the metallic material powder included in the unreacted hydrogen generating material 2a.

On the other hand, it is considered that, in the hydrogen generator of the present invention as shown in FIG. 1 where the water absorbent 7a is disposed on the periphery of the water supply pipe 3, even when the coagulation phenomenon occurs at the boundary (the thick line in FIG. 3), the water absorbent 7a retaining water is positioned at the upper center of the vessel 1 and the water penetrates into the unreacted metallic material powder at which the coagulation phenomenon has not occurred, and thus the reaction proceeds efficiently even for the unreacted hydrogen generating material 2a as shown in FIG. 3.

The material of the water absorbent 7a is not limited particularly as long as it can absorb and retain water. In general, absorbent cotton, nonwoven fabric, cotton fabric, absorbent gauze, sponge and the like can be used.

It is preferable that the water absorbent 7a is disposed on the portion of 30% to 70% of the effective length of the perpendicular portion from the reference plane side, and more preferably, on the portion of 40% to 60% of the effective length from the reference plane side. Since the water absorbent 7a is disposed from the reference plane side, the water supplied from the water supply port 4 disposed in the vicinity of the reference plane of the vessel body la can penetrate smoothly into the water absorbent 7a disposed on the periphery of the water supply pipe 3.

When the water absorbent 7a is disposed on a portion of less than 30% of the effective length, it degrades the effect that water retained in the water absorbent 7a penetrates into the unreacted metallic material powder positioned within the upper center where the coagulation phenomenon has not occurred. On the other hand, when the water absorbent 7a is disposed on a portion of more than 70% of the effective length, the water penetration into the hydrogen outlet 6 side proceeds excessively due to the water absorbent 7a, thereby penetration of water into the vicinity of the reference plane and into the vicinity of the center of the vessel 1 (vicinity of the cross section taken along a line I-I in FIG. 1) becomes difficult, and thus the reaction of the hydrogen generating material 2 positioned in the vicinity of the reference plane and the vicinity of the center of the vessel 1 will be hindered.

In the fuel cartridge 100 as shown in FIG. 1, a water absorbent 7b extends from the end part of the water absorbent 7a positioned oppositely to the reference plane in a direction perpendicular to the water supply pipe 3, and the water absorbent 7b is disposed not to be in contact with the wall surface of the vessel 1. Though the water absorbent 7b is not an essential component, it is disposed preferably to allow water retained in the water absorbent 7b to penetrate into the wide range of the unreacted metallic material powder that is positioned at the upper center where the coagulation phenomenon has not occurred. The water absorbent 7b might be disposed in contact with the wall surface inside the vessel 1. In such a case, however, the water retained in the water absorbent 7b would roll on the wall surface of the vessel 1 so as to degrade the effect that the water penetrates into the unreacted metallic material powder positioned at the upper center where the coagulation phenomenon has not occurred. Therefore, it is preferable that the water absorbent 7b is disposed not to be in contact with the wall surface inside the vessel 1. Further, it is preferable that the water absorbent 7b is disposed when the reference plane of the vessel body 1a is set vertically as shown in FIG. 1. The material of the water absorbent 7b is not limited particularly as long as it can absorb and retain water, and it can be identical to the material of the water absorbent 7a.

In the fuel cartridge 100 as shown in FIG. 1, absorbents 7c and 7d are disposed further at the respective ends of the water supply port 4 and the hydrogen outlet 6 inside the vessel 1. The water absorbent 7c or 7d is not an essential component but it is disposed preferably, since water retained in the water absorbent 7c or 7d is supplied to the hydrogen generating material 2, corresponding to water consumption caused by the hydrogen generation reaction and thus fluctuation of the hydrogen generation rate over time can be suppressed to some degree. Further, the water absorbent 7d is disposed preferably since it plays a role of a filter for preventing the hydrogen generating material 2 from passing through the hydrogen discharging pipe 5 from the hydrogen outlet 6 and flowing out to equipment such as a fuel cell that needs hydrogen. The material of the water absorbent 7c or 7d is not limited particularly as long as it can absorb and retain water, and it can be identical to the material of the water absorbent 7a.

Although the metallic material used in the hydrogen generator of the present invention is not limited particularly as long as it is a material to react with water and generate hydrogen, preferably at least one selected from the group consisting of aluminum, silicon, zinc, magnesium and an alloy based on any of these elements can be used. There is no particular limitation on elements, except for the element to compose the base of the alloy. Here, “compose the base” indicates that the element consists of at least 80 mass % or more preferably at least 90 mass % of the entire alloy. These metallic materials are substances that are difficult to react with water at room temperature but become reactive exothermically with water through heating. In the instant description, “room temperature” indicates temperature in a range of 20 to 30° C.

The metallic materials can react with water and generate hydrogen under a condition heated to at least room temperature. However, since a stable oxide film is formed on the surface, the metallic materials do not generate or hardly generate hydrogen at low temperature or in a form of bulk such as a plate or a block. On the other hand, the existence of the oxide film facilitates handleability of the materials in air.

The metallic material is not limited particularly in the mean particle diameter. Preferably however, the mean particle diameter is not less than 0.1 μm and not more than 100 μm, and more preferably, not less than 0.1 μm and not more than 50 μm. In general, a stable oxide film is formed on the surface of the metallic material. Therefore, in a case of a metallic material in the form of plate, block or a bulk with a particle diameter of 1 mm or more, a reaction with water may not proceed even heated, and in some cases, substantially no hydrogen may be generated. However, if the mean particle diameter of the metallic material is set to 100 μm or less, an action of suppressing reaction with water, which is provided by the oxide film, is decreased. As a result, reaction with water is suppressed at room temperature, but the reactivity with water is enhanced when heated, and the hydrogen generation reaction can be sustained. If the mean particle diameter of the metallic material is set to 50 μm or less, the metallic material can react with water and generate hydrogen even under a mild condition of about 40° C.

Even when the mean particle diameter of the metallic material exceeds 50 μm if the metallic material is in the form of a flake and the thickness is not more than 5 μm, it is possible to enhance the reactivity with water and generate hydrogen more efficiently. In particular, if the thickness of the metallic material is not more than 3 μm, the reaction efficiency can be improved further.

When the mean particle diameter of the metallic material is set to less than 0.1 μm or the thickness of the metal flake material is set to less than 0.1 μm, problems can occur easily, for example, the metallic material would be more ignitable and difficult to handle, or the packing density of the metallic material is lowered so that the energy density will be lowered easily. Therefore, the mean particle diameter of the metallic material is preferably at least 0.1 μm, and when the metallic material is in the form of a flake, the thickness is preferably at least 0.1 μm.

The “mean particle diameter” in the instant description indicates D₅₀ as the value of the diameter of particles with an accumulated volume percentage of 50%. The mean particle diameter may be measured by, for example, a laser diffraction scattering method or the like. More specifically, it is a method of measuring a particle size distribution utilizing a scattering intensity distribution detected by irradiating an object to be measured dispersed in a liquid phase such as water with laser light. As a device for measuring the particle size distribution by the laser diffraction scattering method, “MICROTRAC HRA” manufactured by NIKKISO CO., LTD. is used, for example.

In the instant description, the thickness of the metal flake material will be observed with a scanning electron microscope (SEM).

Though the particle shape of the metallic material is not limited particularly, the examples include a substantial sphere (including a perfect sphere) and a rugby ball shape, and further the above-described form of a flake. In a case of the substantial sphere and the rugby ball shape, the metallic particles preferably meet the mean particle diameter as described above, and in a case of the form of a flake, the metallic particles preferably meet the thickness as described above. It is further preferable that the metal flake material meets also the mean particle diameter as described above.

It is further preferable that at least one substance (hereinafter referred to as additive) selected from the group consisting of a hydrophilic oxide, carbon and a water absorptive polymer is added to the metallic material, so that the reaction between the metallic material and water can be accelerated. For the hydrophilic oxide, alumina, silica, magnesia, zirconia, zeolite, zinc oxide and the like can be used.

For starting easily the exothermic reaction between water and the metallic material, it is preferable that the hydrogen generating material to be used includes an exothermic material that is a material other than the metallic material and that reacts with water to generate heat.

For the exothermic material, any material can be used, as long as the material exothermically reacts with water so as to form a hydroxide or a hydrate, or the material exothermically reacts with water so as to generate hydrogen, for example. Among the exothermic materials, examples of the material that reacts with water to form a hydroxide or hydrate include oxides of alkali metals (such as a lithium oxide), oxides of alkaline-earth metals (such as a calcium oxide and magnesium oxide), chlorides of alkaline-earth metals (such as a calcium chloride and magnesium chloride), and sulfates of alkaline-earth metals (such as a calcium sulfate). Examples of the material that reacts with water to generate hydrogen include alkali metals (such as lithium and sodium) and alkali metal hydrides (such as a sodium borohydride, potassium borohydride and lithium hydride). These materials may be used individually or in combination of two or more.

If the exothermic material is a basic substance, the exothermic material is dissolved in water to be used for hydrogen generation reaction and forms a high concentration alkaline aqueous solution. This is preferred since the alkaline aqueous solution dissolves the oxide film formed on the surface of the metallic material, so that the reactivity with water can be enhanced. The dissolution of the oxide film may be a starting point of the reaction between the metallic material and water. In particular, if the exothermic material is an alkaline-earth metal oxide, it has the advantages of being easy to handle as well as being a basic substance.

For the exothermic materials, a material that reacts exothermically with a substance other than water at room temperature, for example, a material such as an iron powder to react with oxygen and generate heat has been known. However, if the hydrogen generating material includes the material reacting with oxygen and the metallic material as a hydrogen source, the oxygen required for the exothermic reaction may decrease the purity of hydrogen generated from the metallic material or oxidize the metallic material, thus reducing the amount of hydrogen generated. In the present invention, therefore, it is preferable to use the exothermic material selected from the above-described oxides or the like of alkaline-earth metals that react with water to generate heat. For the same reason, it is also preferable that the exothermic material included in the hydrogen generating material does not generate any gas other than hydrogen during the reaction.

Preferably, the content of the metallic material in the entire hydrogen generating material is not less than 85 mass %, and more preferably not less than 90 mass % from the viewpoint of generating more hydrogen. From the viewpoint of further ensuring the effect provided by the combined use of the exothermic materials, preferably, the content of the metallic material in the entire hydrogen generating material is not more than 99 mass %, and more preferably not more than 97 mass %. Preferably the content of the exothermic material in the entire hydrogen generating material is not less than 1 mass %, and more preferably not less than 3 mass %; preferably not more than 15 mass %, and more preferably not more than 10 mass %.

The hydrogen generating material including the exothermic material can be obtained by mixing the metallic material and the exothermic material. During mixing the metallic material and the exothermic material, it is preferable that the metallic material does not form alone an aggregate of 1 mm or more. For example, the metallic material and the exothermic material are stirred and mixed, so that a hydrogen generating material can be produced while suppressing aggregation of the metallic material. Alternatively, it is also possible to coat the exothermic material on the surface of the metallic material and conjugate, thereby providing a hydrogen generating material.

Further, for starting easily the reaction between the hydrogen generating material and water, it is also desirable to heat at least either the hydrogen generating material or water. It is also possible to conduct simultaneously a supply of water into the vessel 1 and the heating.

It is preferable that the temperature to heat at least either the hydrogen generating material or water is not lower than 40° C. and lower than 90° C., and more preferably, not lower than 40° C. and not higher than 70° C. As described above, the temperature for maintaining the exothermic reaction is not lower than 40° C. in general. Once the exothermic reaction starts and hydrogen is generated, the internal pressure of the vessel may rise thereby raising the boiling point of water, and thus the temperature inside the vessel can reach approximately 120° C. Still however, it is preferable to heat within the temperature range as described above from the viewpoint of controlling the hydrogen generation rate.

In a case where the hydrogen generating material includes the above-described exothermic material, the heating can he conducted only at the time of starting the reaction. The reason is that, once the exothermic reaction between the water and the hydrogen generating material starts, the subsequent reaction can be continued by the heat of the exothermic reaction.

The heating method is not limited particularly, but heat can be applied by using heat generated by energizing a resistor. For example, as shown in FIG. 1, a resistor 9 is attached to the outside of the vessel 1 and heated so as to heat the vessel 1 from the outside, so that at least either the hydrogen generating material 2 or water can be heated. There is no particular limitation on the type of the resistor, and for example, metallic heating elements such as Nichrome wire and platinum wire, silicon carbide, PTC thermister or the like can he used.

Alternatively the heating can be conducted by applying heat caused by the chemical reaction of the exothermic material. By disposing the exothermic material on the outside of the vessel and allowing to generate heat so as to heat the vessel from outside, at least either the hydrogen generating material or water can be heated. For the exothermic material, similarly, any of the above-described materials that will exothermically react with water can be used.

The heating can be conducted also by heat generation by a material that exothermically reacts with a substance other than water, for example, a material such as iron powder that exothermically reacts with oxygen. Since oxygen has to be introduced for the exothermic reaction, such a material is disposed preferably outside the vessel and used.

In the case of containing the hydrogen generating material including the exothermic material in the vessel body la and adding water to them for heating, the exothermic material may be used as a mixture prepared by mixing the exothermic material with the metallic material in such a manner as to be dispersed uniformly or nonuniformly. Alternatively, it is preferable to locate a concentrated portion where the content of the exothermic material is higher than the average content of the exothermic material in the entire hydrogen generating material. It is particularly preferable that the concentrated portion is disposed in the vicinity of the water supply port 4 of the water supply pipe 3 inside the vessel body 1a. By concentrating the exothermic material in the vessel body 1a in this way, it is possible to shorten the time from the start of water supply until the metallic material is heated, thus allowing a further prompt hydrogen generation.

For disposing the concentrated portion in the vicinity of the water supply port 4 in the vessel 1, the exothermic material is disposed alone in the vicinity of the water supply port 4. In an alternative method, at least two unit compositions of a metallic material and an exothermic material are prepared, where the unit compositions are different from each other in the contents of the exothermic material. In the method, one of the unit compositions with the highest content of the exothermic material is disposed in the vicinity of the water supply port 4, and a unit composition with the lower content of the exothermic material is disposed at the remaining part.

It is also preferable that the hydrogen generator of the present invention is provided with a water supply portion for supplying water into the vessel 1 containing the hydrogen generating material 2 and a water supply amount control portion for controlling the water supply amount. By controlling the water supply amount, the interior of the vessel 1 can be kept at temperature to maintain the exothermic reaction. Thereby, the exothermic reaction between water and the hydrogen generating material can be continued stably and thus, hydrogen can be produced in a simple, efficient and stable manner. It is preferable that the water supply amount is controlled by controlling the water supply rate.

The temperature for maintaining the exothermic reaction is not lower than 40° C. in general. Once the exothermic reaction starts and hydrogen is generated, the internal pressure of the vessel 1 may rise for raising the boiling point of water, and thus the temperature inside the vessel 1 can reach approximately 120° C. Nevertheless, from the viewpoint of controlling the hydrogen generation rate, temperature of not higher than 100° C. is preferred.

There is no particular limitation on the water supply portion, but a water supply pipe, a water supply port or the like can be applied to the vessel 1. It is also possible to connect a pump or the like to the water supply portion.

The water supply amount control portion is not limited particularly as long as it can control precisely the water supply amount (supply rate), and, for example, a tube pump, a diaphragm pump, a syringe pump or the like can be used. It is also possible to adjust the water supply amount by providing at least two water supply routes different from each other in the water supply rate. For example, by appropriately adjusting the inner diameters of the respective routes, at least two kinds of supply rates can be established.

It is preferable to dispose further a thermal insulator 8 on the outside of the vessel 1. Thereby, the temperature that allows to maintain the exothermic reaction between water and the exothermic material will be kept easily, and influence of the ambient temperature is suppressed. The material of the thermal insulator 8 is not limited particularly as long as it has excellent thermal insulation performance. The examples include porous insulating materials such as polystyrene foam, polyurethane foam, foaming neoprene rubber and the like, and insulating materials having a vacuum insulative structure.

Further, it is preferable that a pressure relief valve is provided to the hydrogen generator of the present invention. For example, even if the hydrogen generation rate is increased and the internal pressure of the device is raised, hydrogen is discharged from the pressure relief valve to the outside of the device, and thus the device can be prevented from breakage. The pressure relief valve can be located anywhere without any particular location as long as it allows to discharge hydrogen generated in the vessel 1 containing the hydrogen generating material 2. For example, in the device as shown in FIG. 1, such a pressure relief valve can be provided to any location from the hydrogen discharging pipe 5 to equipment (not shown) that needs hydrogen.

In the hydrogen generator of the present invention as described above, hydrogen generation amount actually obtained is at least about 60% or more and preferably at least 80% with respect to a theoretical hydrogen generation amount in assumption that the metallic material reacts entirely (in a case of aluminum, theoretical hydrogen generation amount per gram is about 1360 ml in terms of 25° C.) for example, though the value may vary depending on the conditions, and thus hydrogen can be generated efficiently.

### EXAMPLES

Hereinafter, the present invention will be described more specifically with reference to the Examples, though the present invention is not limited to the examples below.

### Example 1

Hydrogen was produced in the following manner by using the fuel cartridge 100 as a hydrogen generator of the present invention as shown in FIG. 4. FIG. 5 is a cross-sectional view taken along a line II-II in FIG. 4. In FIGS. 4 and 5, components identical to those in FIGS. 1 and 2 are assigned with identical signs for avoiding duplication of the description. This applies also to FIGS. 6 to 10 below.

A hydrogen generating material A was prepared by mixing in a mortar 1.0 g of aluminum powder as a metallic material having a mean particle diameter of 6 μm and 1.0 g of calcium oxide powder as an exothermic material having a mean particle diameter of 3μm. Further, a hydrogen generating material B was prepared by mixing in a mortar 98.5 g of the aluminum powder as a metallic material and 12.5 g of the calcium oxide powder as an exothermic material.

Next, 2 g of the hydrogen generating material A (2c in FIGS. 4) and 111.0 g of the hydrogen generating material B (2d in FIG. 4) were supplied to have an inclination as shown in FIG. 4 to fill the vessel 1 of polyethylene (51 mm length, 51 mm width, 105 mm height, 165 cm³ capacity). Further, 0.4 g of absorbent cotton as a water absorbent 7d was provided on the hydrogen generating material B.

Next, a water supply pipe 3 (2 mm inner diameter, 3 mm outer diameter) of aluminum for supplying water was disposed as shown in FIG. 4, and on the periphery of the water supply pipe 3, an absorbent cotton as a water absorbent 7a 2 mm in thickness was disposed across 50% of the above-described effective length. As a water absorbent 7c, 0.1. g of absorbent cotton was disposed at the end of the water supply port 4 of the water supply pipe 3, and the water supply pipe 4 was disposed in the vicinity of the hydrogen generating material A and lidded with a silicon cap provided with a hydrogen discharging pipe 5 (3 mm inner diameter, 4 mm outer diameter) of aluminum for discharging hydrogen, thereby a vessel 1 filled with the hydrogen generating materials A and B was obtained. On the side surface of the vessel 1, a temperature sensor (not shown) for detecting the surface temperature of the vessel 1 was attached. Further, as shown in FIG. 4, a heat insulator 8 of polystyrene foam 5 mm in thickness was set to cover the periphery of the vessel 1.

Next, at the end of the water supply pipe 3 opposite to the vessel 1 side, a pump (not shown) for supplying water to the hydrogen generating materials A and B was provided. Namely, by supplying water with the pump from a water container (not shown), water and the exothermic material included in the hydrogen generating material A (calcium oxide powder) reacts exothermically with each other first, and subsequently, water and the metallic material (aluminum powder) included in the hydrogen generating materials A and B start a hydrogen generation reaction.

Subsequently, pure water was fed from the pump at a rate of 0.8 ml/min. Later, after the temperature of the vessel 1 exceeded 60° C., the pure water was fed at a rate of 2.5 ml/min so as to supply water into the fuel cartridge 100, thereby allowing a reaction between the hydrogen generating material 2 and water so as to generate hydrogen. At 25° C., water supply continued by the time hydrogen generation stopped, and hydrogen was discharged through the hydrogen discharging pipe 5. The generated hydrogen was passed through a calcium chloride pipe so as to remove contained water. And, with a mass-flow meter (made by KOFLOC), reaction rates of aluminum at the termination of steady state and at the termination of the experiment were determined. The experiment starting was set at a time that water supplied through the pump reaches the end (water supply port 4) of the water supply pipe 3, and the experiment termination was set at a time that the instantaneous hydrogen generation rate measured with the mass-flow meter was sustained to be less than 5 ml/min for at least 60 minutes.

The reaction rate was determined as a ratio of an amount of actually obtained hydrogen generation with respect to a theoretical hydrogen generation amount on the assumption that the metallic material reacted entirely (for example, in a case of aluminum, a theoretical hydrogen generation amount per gram is about 1360 ml in terms of 25° C.). The above-described reaction rate was determined from the accumulated hydrogen generation amount calculated by the mass-flow meter.

### Examples 2-3

A hydrogen generator was manufactured in the same manner as Example 1 except that absorbent cotton as the water absorbent 7a was disposed on the periphery of the water supply pipe 3 in accordance with the disposing condition as shown in Table 1. Subsequently, hydrogen was generated in the same manner as Example 1 and the reaction rate was measured.

### Example 4

A hydrogen generator was manufactured in the same manner as Example 1 except that 0.2 g of absorbent cotton as a water absorbent 7b was disposed as shown in FIGS. 6 and 7. Namely, in FIGS. 6 and 7, the water absorbent 7b extends further from the end part of the water absorbent 7a positioned opposite to the above-mentioned reference plane toward the wall surface of the vessel 1 positioned in the upper region, and the water absorbent 7b is not in contact with the wall surface. Subsequently, hydrogen was generated in the same manner as Example 1 and the reaction rate was measured. FIG. 6 is a schematic cross-sectional view of a fuel cartridge used in the present Example, and FIG. 7 is a cross-sectional view taken along a line III-III in FIG. 6.

### Comparative Example 1

A hydrogen generator was manufactured in the same manner as Example 1 except that no absorbent was disposed on the periphery of the water supply pipe 3 as shown in FIGS. 8 and 9. Subsequently, hydrogen was generated in the same manner as Example 1 and the reaction rate was measured. FIG. 8 is a schematic cross-sectional view of a fuel cartridge used in the present Comparative Example, and FIG. 9 is a cross-sectional view taken along a line IV-IV in FIG. 8.

### Comparative Example 2

A hydrogen generator was manufactured in the same manner as Example 1 except that absorbent cotton as the water absorbent 7a was disposed on the periphery of the water supply pipe 3 in accordance with the disposing condition as shown in Table 1. Subsequently, hydrogen was generated in the same manner as Example 1 and the reaction rate was measured.

### Comparative Example 3

A hydrogen generator was manufactured in the same manner as Example 1 except that absorbent cotton as a water absorbent 7a was disposed on the entire periphery of the perpendicular portion of the water supply pipe 3 as shown in FIG. 10. Subsequently, hydrogen was generated in the same manner as Example 1 and the reaction rate was measured.

Table 1 shows conditions for disposing the water absorbent 7a, and reaction rates of aluminum at the termination of steady stat and at the termination of experiment in Examples 1-4 and Comparative Examples 1-3. FIG. 11 is a graph showing relationships between hydrogen generation rates and elapsed times in Example 1 and Comparative Example 1.

| | Disposition of | Reaction rate | |
|---|---|---|---|
| | absorbent 7a | of aluminum | |
| | Ratio of effective | At termination | At termination |
| | length of perpendicular | of | of |
| | portion in contact with | steady state | experiment |
| | water absorbent (%) | (%) | (%) |
| Example 1 | 50 | 56 | 81 |
| Example 2 | 20 | 54 | 80 |
| Example 3 | 80 | 52 | 78 |
| Example 4 | 50 | 61 | 83 |
| Comparative | 0 | 46 | 72 |
| Example 1 | | | |
| Comparative | 90 | 42 | 64 |
| Example 2 | | | |
| Comparative | 100 | 36 | 49 |
| Example 3 | | | |

In each of Examples 1-3, hydrogen was generated at a final reaction rate of about 80% or more and at a reaction rate of about 50% or more at the termination of the steady state. Particularly, in the case of Example 1, the final reaction rate was as high as 81% at the termination of the reaction and 56% at the termination of the steady state, and thus hydrogen was generated stably and efficiently. On the other hand, in Comparative Example 1 where the water absorbent 7a was not disposed, the reaction rate of aluminum was degraded both at the termination of the steady state and at the termination of experiment. Particularly, it is evident from FIG. 11 that the reaction rate was degraded considerably after the termination of the steady state. The reason is considered as follows. That is, since any absorbent is not disposed on the periphery of the water supply pipe 3, an alumina hydrate as a reaction product remaining on the particle surface at the time of the reaction between the aluminum powder and water and an unreacted aluminum powder coagulate. This coagulation phenomenon occurs at the boundary between the unreacted hydrogen generating material 2a and the reacted hydrogen generating material 2b as shown in FIG. 3, and thus water penetration into the particle interiors of the unreacted aluminum powder became difficult. As a result, the hydrogen generation efficiency was degraded.

In each of Comparative Examples 2-3 where the water absorbent 7a was disposed even on the portion of less than 15% of the effective length of the water supply pipe 3 on the hydrogen outlet 6 side, where the water supply pipe 3 extends perpendicularly from the reference plane of the vessel 1, the reaction rate of aluminum was degraded at the termination of the steady state and also at the termination of the experiment. Particularly, it is evident from Table 1 that, the reaction rates at the termination of the steady state were degraded considerably. The reason is considered as follows. That is, in a case where the water absorbent 7a to be disposed on the periphery of the water supply pipe 3 is disposed also on the portion of less than 15% of the effective length of the water supply pipe 3 on the hydrogen outlet 6 side, water penetration into the hydrogen outlet 6 side proceeds excessively, and thus water penetration into the vicinity of the reference plane and into the vicinity of the center of the vessel 1 became difficult. And this hindered the reaction of the hydrogen generator 2 positioned in the vicinity of the reference plane and in the vicinity of the center of the vessel 1.

From a comparison of the reaction rates of aluminum at the termination of the steady state and at the termination of the experiment for Example 1 and Example 4, it was clarified that the reaction rates for both states in Example 4 were higher than those in Example 1. The reason is considered as follows. That is, due to the disposition of the water absorbent 7b, water was allowed to penetrate into the wider range of the unreacted aluminum powder positioned in the upper center of the vessel 1 where the above-mentioned coagulation phenomenon has not occurred. As a result, the hydrogen generation efficiency was improved.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

As described above, the hydrogen generator of the present invention can produce hydrogen simply and efficiently at low temperature not higher than 100° C. Hydrogen produced by use of the hydrogen generator of the present invention can be supplied to a fuel cell, and in particular, can be utilized widely as a fuel source for a fuel cell, in particular, a fuel cell for small portable equipment or the like.

1. A hydrogen generator comprising a vessel for containing a hydrogen generating material comprising a metallic material for generating hydrogen by an exothermic reaction with water,
the vessel comprises a water supply pipe for supplying water into the vessel and a hydrogen outlet for discharging hydrogen generated inside the vessel to the outside of the vessel;
a wall surface of the vessel facing the hydrogen outlet is set as a reference plane;
a water supply port at the end of the water supply pipe disposed inside the vessel is disposed in the vicinity of the reference plane;
the water supply pipe comprises a perpendicular portion extending from the vicinity of the center of the reference plane in a direction perpendicular to the reference plane;
a water absorbent is disposed on the periphery of the perpendicular portion of the water supply pipe; and
the water absorbent is not disposed on a portion of 15% or more of an effective length of the perpendicular portion of the water supply pipe on the hydrogen outlet side.

2. The hydrogen generator according to claim 1, wherein the water absorbent is disposed on a portion of 30% to 70% of the effective length of the perpendicular portion of the water supply pipe from the reference plane side.

3. The hydrogen generator according to claim 1, wherein the water absorbent extends further from the end of the water absorbent positioned opposite to the reference plane in a direction perpendicular to the water supply pipe, and the water absorbent is not in contact with the wall surface of the vessel.

4. The hydrogen generator according to claim 1, wherein the water absorbent is disposed also at respective ends of the water supply port and the hydrogen outlet.

5. The hydrogen generator according to claim 1, wherein the water absorbent is selected from the group consisting of absorbent cotton, nonwoven fabric, cotton fabric, absorbent gauze and sponge.

6. The hydrogen generator according to claim 1, wherein the metallic material is at least one selected from the group consisting of aluminum, silicon, zinc, magnesium and an alloy based on any of aluminum, silicon, zinc and magnesium.

7. The hydrogen generator according to claim 1, wherein the hydrogen generating material comprises further an exothermic material that is a material other than the metallic material and that generates heat by a reaction with water.

8. The hydrogen generator according to claim 7, the exothermic material is at least one selected from the group consisting of calcium oxide, magnesium oxide, calcium chloride, magnesium chloride, and calcium sulfate.

9. The hydrogen generator according to claim 7, wherein the hydrogen generating material has a concentrated portion where the content of the exothermic material is higher than the average content of the exothermic material in the entire hydrogen generating material.

10. The hydrogen generator according to claim 9, wherein the hydrogen generating material is disposed such that the concentrated portion is supplied with water first at the time of supplying water into the vessel.

11. The hydrogen generator according to claim 7, wherein the hydrogen generating material comprises at least two kinds of unit compositions different from each other in the contents of the exothermic material.

12. The hydrogen generator according to claim 11, wherein the hydrogen generating material is disposed such that a unit composition with the highest content of the exothermic material among the unit materials is supplied first with water at the time of supplying water into the vessel.

13. The hydrogen generator according to claim 1, further comprising a water supply portion for supplying water into the vessel and a water supply amount control portion for controlling an water supply amount.

14. The hydrogen generator according to claim 1, further comprising a heat insulator disposed on the outside of the vessel.
